(19) United States
(12) Patent Application Publication
(10) Pub. No.: US 2026/0264441 A1
(43) Pub. Date: Sep. 10, 2026

(54) BOOK ANNOTATION SYSTEM

(71) Applicant: Archetype Associates dba Designers & Books, Brooklyn, NY (US)

(72) Inventor: Steven W. Kroeter, Brooklyn, NY (US)

(21) Appl. No.: 19/074,993

(22) Filed: Mar. 10, 2025

(51) Int. Cl. B42D 3/14

(52) U.S. Cl. CPC B42D 3/14; B42P 2241/18

(57) ABSTRACT

A book annotation system includes a cover configured to be disposed upon an exterior surface of a book; a writing utensil; a writing utensil holder configured to retain the writing utensil; a stationery kit; and a stationery kit holder configured to retain the stationery kit. The cover includes a first flap; a first surface extending from an edge of the first flap; a second flap; a second surface extending from an edge of the second flap; and a central surface defined between a first edge of the first surface and a first edge of the second surface.

### TECHNICAL FIELD

The subject matter of the present disclosure relates generally to book annotation systems and, in particular, systems that can be integrated into a book for easy access during reading.

### BACKGROUND

Annotating books using physical tools such as pens, highlighters, sticky notes, and rulers presents a considerable inconvenience, particularly due to the necessity of carrying these items around at all times. Managing multiple annotation tools can be cumbersome, as pens are easily misplaced, highlighters may dry out, and sticky notes can become crumpled or detached, thereby disrupting an organized note-taking system. For individuals who read while commuting, traveling, or moving between locations, remembering to pack, or retrieving the appropriate tool from a bag, can be both inconvenient and disruptive to the reading experience. Furthermore, the added bulk of stand-alone annotation materials can make carrying books less practical, particularly for those who prefer to travel light. This issue is especially pronounced for individuals who read in various locations, as moving between spaces increases the likelihood of forgetting or misplacing annotation tools. Consequently, the frequent loss or misplacement of these items can cause loss of the important thought to be remembered through annotation and/or interrupt the reading process, creating frustration and diminishing the efficiency of notetaking.

Accordingly, there is a need for book annotation systems and, in particular, systems that can be integrated into a book for easy access during reading.

### SUMMARY

An aspect of the present disclosure provides a book annotation system. The book annotation system includes a cover configured to be disposed upon an exterior surface of a book; a writing utensil; a writing utensil holder configured to retain the writing utensil; a f kit; and a stationery kit holder configured to retain the stationery kit. The cover includes a first flap; a first surface extending from an edge of the first flap; a second flap; a second surface extending from an edge of the second flap; and a central surface defined between a first edge of the first surface and a first edge of the second surface.

In an aspect of the present disclosure, the cover may be a hard cover cover.

In another aspect of the present disclosure, the hard cover cover may be composed of book board, cloth, paper, leather, canvas, and/or vinyl.

In yet another aspect of the present disclosure, the cover may be a soft cover cover.

In an aspect of the present disclosure, the soft cover cover may be composed of cardstock, coated paper, uncoated paper, laminated paper, plastic, and/or fabric.

In another aspect of the present disclosure, the first flap may be configured to fold into a first cover portion of the book such that the first surface sits flush with the first cover portion of the book.

In yet another aspect of the present disclosure, the first flap may be configured to fold along the edge of the first flap.

In another aspect of the present disclosure, the second flap may be configured to fold into a second cover portion of the book such that the second surface sits flush with the second cover portion of the book.

In yet another aspect of the present disclosure, the second flap may be configured to fold along the edge of the second flap.

In an aspect of the present disclosure, the first surface and the second surface may be texturized.

In another aspect of the present disclosure, the central surface may be configured to sit flush with a spine of the book, and the first edge of the first surface and the first edge of the second surface may be configured to sit flush with an external perimeter of the spine of the book.

In an aspect of the present disclosure, the central surface may be configured to retain the writing utensil holder.

In another aspect of the present disclosure, the writing utensil holder may be connected to the central surface using a loop, a magnet, a clip, an adhesive, a pocket, a hook and loop fastener, and/or a binder mechanism.

In yet another aspect of the present disclosure, a surface area of the central surface may be identical to a surface area of the spine of the book.

In an aspect of the present disclosure, the writing utensil may be a pen, pencil, marker, highlighter, and/or crayon.

In another aspect of the present disclosure, the second surface may be configured to retain the stationery kit holder.

In yet another aspect of the present disclosure, the stationery kit holder may be connected to the second surface using a loop, a magnet, a clip, an adhesive, a pocket, a hook and loop fastener, and/or a binder mechanism.

In an aspect of the present disclosure, the stationery kit holder may be disposed on the second flap.

In another aspect of the present disclosure, the stationery kit may include a notepad, page flags, index cards, an eraser, a ruler, a scissor, a glue stick, stickers, tape, a paper clip, and/or a bookmark.

In yet another aspect of the present disclosure, the cover may be configured to be equivalent in size to the exterior surface of the book upon which the cover is disposed.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is an illustration of a book annotation system, in accordance with aspects of the present disclosure;

FIG. 2 is a cross-sectional side perspective view of the book annotation system of FIG. 1, in accordance with aspects of the present disclosure;

FIG. 3 is an illustration of the book annotation system of FIG. 1, in accordance with aspects of the present disclosure;

FIG. 4 is a side perspective view of the book annotation system of FIG. 1, in accordance with aspects of the present disclosure;

FIG. 5 is a side perspective view of the book annotation system of FIG. 1, in accordance with aspects of the present disclosure;

FIG. 6 is a bottom perspective view of the book annotation system of FIG. 1, in accordance with aspects of the present disclosure;

FIG. 7A is a top perspective view of the book annotation system of FIG. 1, in accordance with aspects of the present disclosure; and

FIG. 7B is a top perspective view of the book annotation system of FIG. 1, in accordance with aspects of the present disclosure.

### DETAILED DESCRIPTION

The present disclosure relates generally to book annotation systems and, in particular, systems that can be integrated into a book for easy access during reading.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

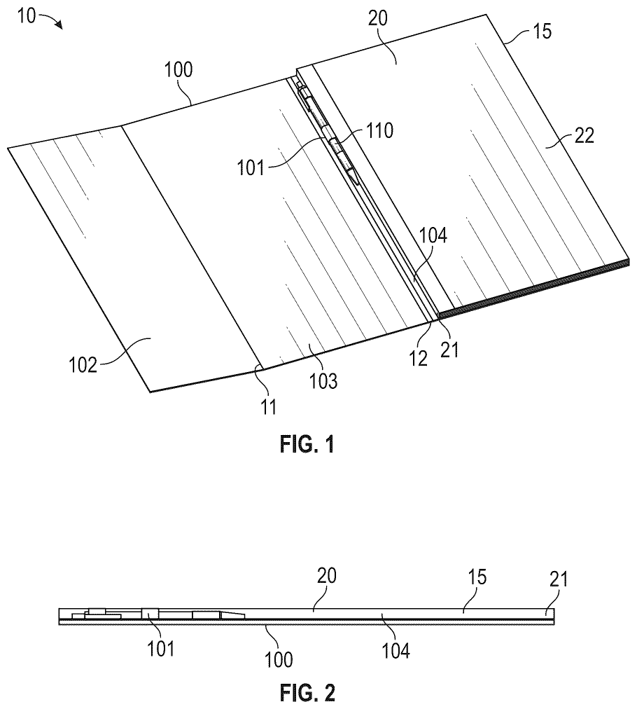

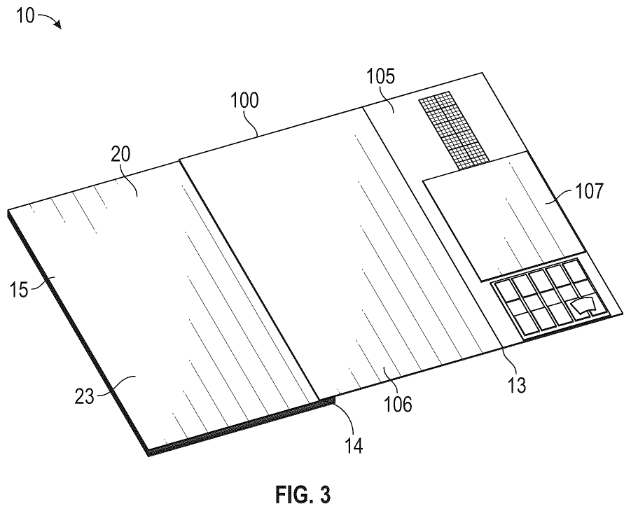

Referring to FIGS. 1-7B, a book annotation system 10 (FIGS. 1 and 3) is shown in accordance with aspects of the present disclosure. System 10 includes a cover 100 configured to be disposed upon an exterior surface 20 of a book 15, a writing utensil 110, a writing utensil holder 101 configured to retain writing utensil 110, a stationery kit 150, and a stationery kit holder 107 configured to retain stationery kit 150. Cover 100 may be of varying sizes and dimensions to accommodate diverse formats, sizes, and styles of books 15. For example, books 15 of different genres and purposes (e.g., novels, textbooks, coffee table books, trade books, and pocket-sized guides) require covers 100 that complement their intended use. In embodiments, cover 100 is configured to be equivalent in size to exterior surface 20 of book 15 upon which cover 100 is disposed. A spine 21 of cover 100 may also vary in size and dimension depending on page count and paper thickness. In various embodiments, cover 100 may include glossy, matte, or textured finishes to help protect against dirt, moisture, and wear. Further, cover 100 may have rounded or reinforced corners to help prevent fraying and damage from frequent use, particularly for textbooks and reference books. Cover 100 may also be composed of synthetic or treated materials that are water-resistant and weatherproof to help protect book 15 from spills and environmental damage.

In embodiments, cover 100 may be a hard cover cover 100. Hard cover cover 100 offers several advantages related to durability, longevity, and aesthetic appeal. Namely, hard cover cover 100 offers enhanced sturdiness, protecting pages from bending, creasing, and other damage that might occur over time, ensuring that book 15 maintains its shape and quality long-term. Additionally, hard cover cover 100 tends to be more resistant to wear and tear, making it ideal for repeated handling, storage, and transportation. Enhanced durability is especially valuable for reference books, textbooks, and frequently used literary works that need to withstand extended use. Hard cover cover 100 may be composed of a wide variety of materials including, but not limited to, book board, cloth, paper, leather, canvas, and/or vinyl.

In other embodiments, cover 100 may be a soft cover cover 100. Soft cover cover 100 also offers a number of advantages related to affordability, flexibility, and overall weight. Namely, it is generally less expensive to produce than a hard cover edition, appealing to a wider audience of readers. Additionally, the lightweight and flexible nature of soft cover cover 100 makes it easier to carry, store, and transport, making it an ideal choice for students, travelers, and casual readers who prefer convenience over formal presentation and bulkiness as soft cover cover 100 can generally fit easily into bags and backpacks without adding significant weight. The flexibility of soft cover cover 100 also means it can be produced in various trim sizes. Further, soft cover cover 100 tends to have better handling comfort, as its pliability makes it easier to hold and read for extended periods. Soft cover cover 100 may be composed of a wide variety of materials including, but not limited to, cardstock, coated paper, uncoated paper, laminated paper, plastic, and/or fabric.

Cover 100 includes a first flap 102, a first surface 103 extending from an edge 11 of first flap 102, a second flap 105, a second surface 106 extending from an edge 13 of second flap 105, and a central surface 104 defined between a first edge 12 of first surface 103 and a first edge 14 of second surface 106. First flap 102 is configured to fold into a first cover portion 22 of book 15 such that first surface 103 sits flush with first cover portion 22 of book 15. Namely, first flap 102 is configured to fold along edge 11 of first flap 102. Similarly, second flap 105 is configured to fold into a second cover portion 23 of book 15 such that second surface 106 sits flush with second cover portion 23 of book 15. Second flap 105 is configured to fold along edge 13 of second flap 105. First flap 102 and second flap 105 may be of varying sizes and dimensions to accommodate different books 15 and to encase first cover portion 22 and second cover portion 23 of book 15 to different extents. First flap 102 and second flap 105 serve multiple purposes, such as adding an extra layer of protection to book 15 and enhancing the overall aesthetic appeal. Depending on the format and design of book 15, first flap 102 and second flap 105 may be narrow, just enough to tuck inside first cover portion 22 and second cover portion 23 of book 15 or can extend further to wrap around a significant portion of first cover portion 22 and second cover portion 23 of book 15 for a more secure fit. The thickness of the material used to form first flap 102 and second flap 105 may also influence how well first flap 102 and second flap 105 encase book 15, with heavier material providing better durability and resistance to bending. In embodiments, first flap 102 and second flap 105 may include small, embedded magnets that can help keep first flap 102 and second flap 105 securely closed, preventing damage to book 15 and ensuring it stays protected when not in use. Alternatively, an elastic strap may be attached to either first flap 102 or second flap 105, or both, that can wrap around book 15 to keep it closed. In some embodiments, first flap 102 and second flap 105 may include extra folds or extensions that can provide additional space for notes, maps, or diagrams. Additionally, a thin LED strip embedded in first flap 102 and/or second flap 105 can provide subtle lighting for reading in low-light conditions.

When first flap 102 is folded into first cover portion 22 of book 15, first surface 103 preferably sits flush with first cover portion 22 of book 15. Similarly, when second flap 105 is folded into second cover portion 23 of book 15, second surface 106 preferably sits flush with second cover portion 23 of book 15. In various embodiments, first surface 103 and second surface 106 may be of varying sizes and dimensions to accommodate diverse formats and styles of book 15. Further, first surface 103 and second surface 106 may be texturized to enhance grip, making it easier to hold and carry book 15 without it slipping. Additionally, different textures can add a tactile and sensory experience. The use of a textured first surface 103 and second surface 106 can also offer protection against scratches, smudges, and general wear. In embodiments, a wide variety of textures may be implemented including, but not limited to, leather-grain finishes, linen finishes, fabric finishes, embossed and/or debossed patterns, rubberized coatings, and/or matte coatings. In some embodiments, first surface 103 and second surface 106 may also feature raised elements or grip-enhancing materials, such as silicone inserts, which can be particularly useful for textbooks, workbooks, or frequently used reference materials. First surface 103 and second surface 106 may include extra folds or extensions, enhancing versatility and promoting customization of shape.

In embodiments, second surface 106 is configured to retain stationery kit holder 107. Stationery kit holder 107 may be connected to second surface 106 using a wide variety of connection mechanisms including, but not limited to, a loop (e.g., elastic, rubber, fabric), a magnet, a clip, an adhesive, a pocket, a hook and loop fastener, or a binder mechanism. In some embodiments, stationery kit holder 107 may be disposed on second flap 105. Alternatively, in other embodiments, stationery kit holder 107 may be disposed on first flap 102 or first surface 103. Having stationery kit holder 107 directly attached to cover 100 encasing book 15 offers numerous benefits, particularly for readers, students, and professionals who need to take quick, organized notes. Namely, convenience is greatly enhanced as having everything in one place eliminates the need to search for separate pens, highlighters, or note pads, saving valuable time and reducing distractions. Stationery kit holder 107 is configured to retain stationery kit 150 which may include a wide variety of annotation tools including, but not limited to, a notepad, page flags, index cards, an eraser, a ruler, a scissor, a glue stick, stickers, tape, a paper clip, or a bookmark that are all neatly stored in a designated area on cover 100, making it ideal for readers who need to annotate book 15 in various ways. By attaching stationery kit holder 107 to cover 100, the necessary annotation tools are always within reach, minimizing the risk of forgetting or misplacing these items and the need to carry these tools in a separate pouch or storage unit. In some embodiments, stationery kit holder 107 can also include pockets or slots for additional items, such as a pencil sharpener, eraser, lightly gridded blank pages, or even a small notebook for more in-depth notes, creating a compact, all-in-one solution for reading and note-taking. Moreover, this feature can enhance the portability of the book, making it ideal for readers who are constantly on the go. Additionally, having stationery kit holder 107 attached to cover 100 can contribute to the longevity of both the book and the annotation tools of stationery kit 150, as they are less likely to get damaged or lost when stored securely in a dedicated space.

Stationery kit holder 107 may also be of varying sizes, shapes, and dimensions to properly accommodate different stationery kits 150 holding a wide variety of annotation tools. In various embodiments, stationery kit holder 107 may include adjustable dividers or compartments to help organize various stationery items of stationery kit 150, keeping them separated and easily accessible. Further, stationery kit holder 107 may include elastic straps or loops that can help hold stationery kit 150 in place. Stationery kit holder 107 may be composed of reinforced or stiffened material with a stiffer backing or padding to help maintain its shape over time, preventing it from becoming deformed with frequent use. In some embodiments, stationery kit holder 107 may include foldable or expandable pockets to help increase storage space as needed. For example, in embodiments, a flag dispenser may be disposed directly on second surface 106 while stationery kit holder 107 includes a pocket within which a ruler is disposed. In other embodiments, stationery kit holder 107 may include a plurality of pockets within which various stationery items (e.g., flag dispenser, ruler) may be held separate from one another. Alternatively, the stationery items may be stored in the same pocket rather than being stored in various separate pockets. Further, stationery kit holder 107 may include a slot through which sticky notes or index tabs can be inserted and later extracted as needed by a reader. Stationery kit holder 107 may also include a rubberized grip or soft padding to ensure that stationery kit 150 is held securely in place without sliding or falling out. Stationery kit holder 107 may also be detachable such that stationery kit holder 107, and inherently stationery kit 150, can be removed from cover 100 and attached elsewhere.

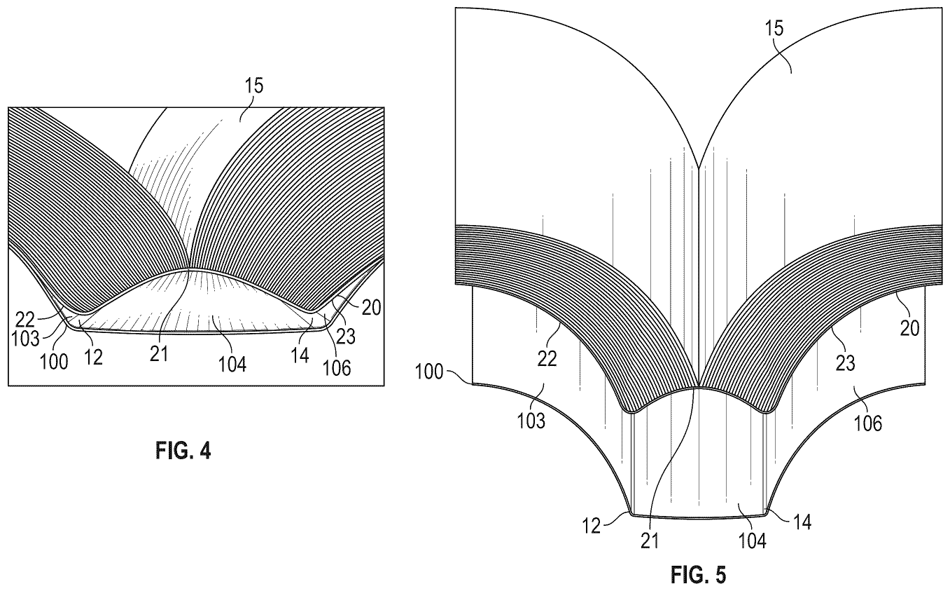

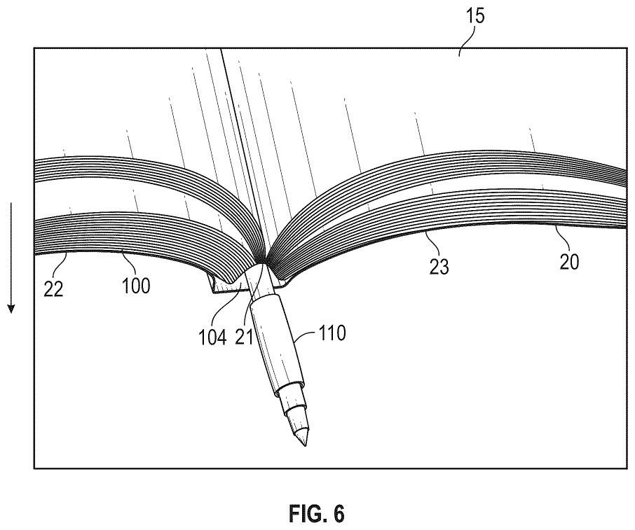

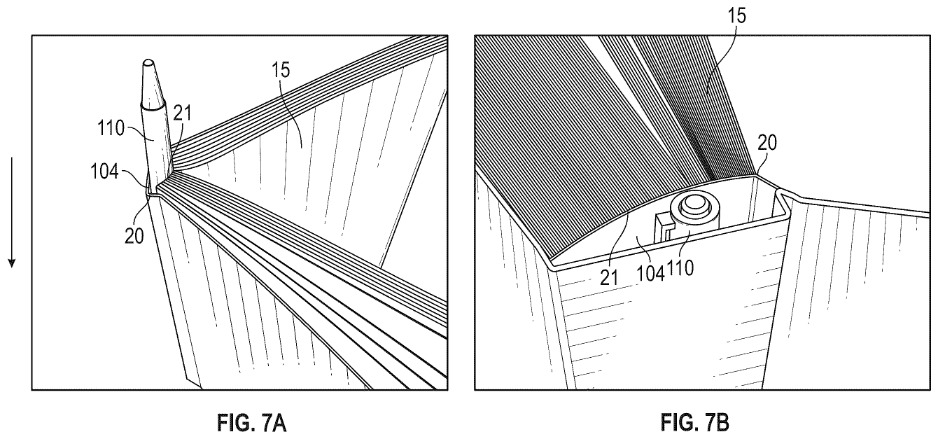

Central surface 104 is defined between first edge 12 of first surface 103 and first edge 14 of second surface 106. Central surface 104 is configured to sit flush with spine 21 of book 15 (FIGS. 4-5). Further, first edge 12 of first surface 103 and first edge 14 of second surface 106 are configured to sit flush with an external perimeter of spine 21 of book 15. Accordingly, a surface area of central surface 104 is configured to be identical to a surface area of spine 21 of book 15. However, in some embodiments, the surface area of central surface 104 may be of varying sizes and dimensions to accommodate diverse formats and styles of book 15. In embodiments, central surface 104 may be made from thicker, more durable materials than the rest of cover 100 that can help prevent creasing and damage, especially in frequently used books 15 like textbooks and journals. Alternatively, having a flexible or rounded central surface 104 allows book 15 to open more smoothly, reducing strain on spine 21 and improving its longevity. In some embodiments, textured or rubberized grip sections may be implemented on central surface 104 to improve handling, making it easier to carry and hold the book. A built-in bookmark ribbon attached to central surface 104 can offer convenience for readers who need to mark their place. Additionally, central surface 104 may feature a hidden storage compartment or clip-on accessories (e.g., accessory holders or note clips), providing space for notes or small accessories (e.g., a pen, pencil, highlighter) (FIGS. 6-7B).

In various embodiments, central surface 104 is configured to retain writing utensil holder 101 (FIGS. 1-2 and 6-7B). Writing utensil holder 101 may be connected to central surface 104 using a wide variety of connection mechanisms including, but not limited to, a loop (e.g., elastic, rubber, fabric), a magnet, a clip, an adhesive, a pocket, a hook and loop fastener, or a binder mechanism. Writing utensil holder 101 may be composed of a variety of suitable materials including leather, elastic fabric, silicone, nylon, polyester, canvas, vinyl, felt, metal, plastic, acrylic, and/or wood. Writing utensil holder 101 may include an adjustable elastic band or strap, allowing it to accommodate different writing utensil 110 sizes. Writing utensil holder 101 may also be of varying sizes and dimensions to properly accommodate different writing utensil 110 sizes. Further, writing utensil holder 101 may include multiple compartments that can allow for the storing of different types of writing utensils 110 in a single location all at once (e.g., both a pen and a highlighter simultaneously). Further, in embodiments, a plurality of writing utensil holders 101 may be disposed along central surface 104 such that a plurality of writing utensils 110 may be stored in the plurality of writing utensil holders 101 at once and next to one another. Writing utensil holder 101 may also include a rubberized grip or soft padding to ensure that writing utensil 110 is held securely in place without sliding or falling out. Additionally, writing utensil holder 101 may include a small magnetic closure or snap at an opening of writing utensil holder 101 that can help keep it securely shut, ensuring writing utensil 110 remains in place. Writing utensil holder 101 may also be disposed on either first flap 102, second flap 105, first surface 103, or second surface 106. Writing utensil holder 101 may also be detachable such that writing utensil holder 101 can be removed from cover 100 and attached elsewhere. In various embodiments, writing utensil 110 may be disposed directly within a cavity defined between central surface 104 and spine 21 such that writing utensil 110 may be inserted and held in the cavity without the need for writing utensil holder 101 (FIGS. 6-7B). In some embodiments, writing utensil 110 retained within writing utensil holder 101 may be a pen, pencil, marker, highlighter, or crayon.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

What is claimed is:

1. A book annotation system, comprising:
a cover configured to be disposed upon an exterior surface of a book, the cover comprising:
a first flap;
a first surface extending from an edge of the first flap;
a second flap;
a second surface extending from an edge of the second flap; and
a central surface defined between a first edge of the first surface and a first edge of the second surface;
a writing utensil;
a writing utensil holder configured to retain the writing utensil;
a stationery kit; and
a stationery kit holder configured to retain the stationery kit.

2. The system of claim 1, wherein the cover is a hard cover cover.

3. The system of claim 2, wherein the hard cover cover is composed of at least one of: book board, cloth, paper, leather, canvas, or vinyl.

4. The system of claim 1, wherein the cover is a soft cover cover.

5. The system of claim 4, wherein the soft cover cover is composed of at least one of: cardstock, coated paper, uncoated paper, laminated paper, plastic, or fabric.

6. The system of claim 1, wherein the first flap is configured to fold into a first cover portion of the book such that the first surface sits flush with the first cover portion of the book.

7. The system of claim 6, wherein the first flap is configured to fold along the edge of the first flap.

8. The system of claim 1, wherein the second flap is configured to fold into a second cover portion of the book such that the second surface sits flush with the second cover portion of the book.

9. The system of claim 8, wherein the second flap is configured to fold along the edge of the second flap.

10. The system of claim 1, wherein the first surface and the second surface are texturized.

11. The system of claim 1, wherein the central surface is configured to sit flush with a spine of the book, and wherein the first edge of the first surface and the first edge of the second surface are configured to sit flush with an external perimeter of the spine of the book.

12. The system of claim 1, wherein the central surface is configured to retain the writing utensil holder.

13. The system of claim 12, wherein the writing utensil holder is connected to the central surface using at least one of: a loop, a magnet, a clip, an adhesive, a pocket, a hook and loop fastener, or a binder mechanism.

14. The system of claim 11, wherein a surface area of the central surface is identical to a surface area of the spine of the book.

15. The system of claim 1, wherein the writing utensil is at least one of: a pen, pencil, marker, highlighter, or crayon.

16. The system of claim 1, wherein the second surface is configured to retain the stationery kit holder.

17. The system of claim 16, wherein the stationery kit holder is connected to the second surface using at least one of: a loop, a magnet, a clip, an adhesive, a pocket, a hook and loop fastener, or a binder mechanism.

18. The system of claim 1, wherein the stationery kit holder is disposed on the second flap.

19. The system of claim 1, wherein the stationery kit includes at least one of: a notepad, page flags, index cards, an eraser, a ruler, a scissor, a glue stick, stickers, tape, a paper clip, or a bookmark.

20. The system of claim 1, wherein the cover is configured to be equivalent in size to the exterior surface of the book upon which the cover is disposed.
